(19) United States
(12) Patent Application Publication
(10) Pub. No.: US 2019/0068819 A1
(43) Pub. Date: Feb. 28, 2019

(54) INFORMATION PROCESSING APPARATUS, POWER CONTROL METHOD IN INFORMATION PROCESSING APPARATUS, AND STORAGE MEDIUM

(71) Applicant: CANON KABUSHIKI KAISHA, Tokyo (JP)

(72) Inventor: Atsushi Hikichi, Tokyo (JP)

(21) Appl. No.: 16/112,026

(22) Filed: Aug. 24, 2018

(30) Foreign Application Priority Data
Aug. 31, 2017 (JP) 2017-167498

(51) Int. Cl. H04N 1/00

(52) U.S. Cl. CPC H04N 1/00896; H04N 2201/0094; H04N 1/00891; H04N 1/00933

(57) ABSTRACT

An information processing apparatus including a device and a controller that controls the device, and the controller has: a power control unit capable of controlling a power state of the information processing apparatus between a first power state where at least supply of power to the device is performed and a second power state where power consumption is smaller than that of the first power state and supply of power to the device is stopped; and the power control unit: causes the power state to return to the first power state in a case where an occurrence of an event is detected; and further returns the power state to the second power state in a case where the event that has occurred is an adjustment event for causing the device to perform adjustment processing on a condition that the adjustment processing performed in accordance with the adjustment event is completed.

### BACKGROUND OF THE INVENTION

### Field of the Invention

The present invention relates to power control of an information processing apparatus and particularly, to power control of an image forming apparatus, such as a multi function printer including a printer device and a scanner device.

### Description of the Related Art

An image forming apparatus, such as a multi function printer, returns from a sleep state and turns on the power source upon receipt of a job or the like in a power-saving mode (sleep state). The sleep state is a state capable of reducing the activation time compared to that at the time of normal activation while suppressing power consumption. Upon completing the received job or the like, the image forming apparatus makes transition into the sleep state again. At this time, the image forming apparatus continues the power-on state for a predetermined time instead of immediately making transition into the sleep state after the job or the like is completed. The reason is to prevent the power source of the image forming apparatus from being turned on and off repeatedly in the case of receiving jobs continuously. In this manner, in the image forming apparatus, the product life of a relay switch, a nonvolatile storage device, and so on, whose number of times the power source is turned on is limited, is guaranteed by preventing the number of times the power source is turned on from increasing more than necessary.

Japanese Patent Laid-Open No. 2010-156862 has described an image forming apparatus that performs printer adjustment processing by returning from sleep at predetermined time intervals during sleep. The printer adjustment processing is, for example, processing to slightly rotate a pressure roller (hereinafter, represented as “slight rotation”) by returning from sleep every several hours in order to prevent a fixing film unit and the pressure roller from hardening in a state of being crimped and deformed. Alternatively, the printer adjustment processing is, for example, automatic gradation correction.

However, a possibility that maintenance processing, such as printer adjustment processing, is performed continuously is faint. Consequently, at the time of returning from sleep in order to perform such processing, in the case where the power-on state is continued as described above, power is consumed wastefully.

Consequently, an object of the present invention is to reduce power consumption accompanying adjustment processing performed during sleep in an information processing apparatus, such as an image forming apparatus.

### SUMMARY OF THE INVENTION

The information processing apparatus according to the present invention is an information processing apparatus including a device and a controller that controls the device, and the controller has: a power control unit capable of controlling a power state of the information processing apparatus between a first power state where at least supply of power to the device is performed and a second power state where power consumption is smaller than that of the first power state and supply of power to the device is stopped; and a monitoring unit configured to monitor an occurrence of an event that causes the power state to return to the first power state from the second power state, and the power control unit: causes the power state to return to the first power state in a case where an occurrence of an event is detected by the monitoring unit; and further returns the power state to the second power state in a case where the event that has occurred is an adjustment event for causing the device to perform adjustment processing on a condition that the adjustment processing performed in accordance with the adjustment event is completed.

Further features of the present invention will become apparent from the following description of exemplary embodiments with reference to the attached drawings.

### BRIEF DESCRIPTION OF THE DRAWINGS

FIG. 1 is a block diagram showing a configuration of an image forming system according to a first embodiment;

FIG. 2 is a schematic diagram of a section of an image forming apparatus according to the first embodiment;

FIG. 3 is a block diagram showing an internal configuration of a controller;

FIG. 4 is a block diagram showing a power source configuration of the image forming apparatus according to the first embodiment;

FIG. 5 is a diagram showing the relationship of FIG. 5A and FIG. 5B;

FIG. 5A is a flowchart showing an operation of the first embodiment of the controller;

FIG. 5B is a flowchart showing an operation of the first embodiment of the controller;

FIG. 6 is a diagram showing the relationship of FIG. 6A and FIG. 6B;

FIG. 6A is a flowchart showing an operation of a second embodiment of a controller; and

FIG. 6B is a flowchart showing an operation of a second embodiment of a controller.

### DESCRIPTION OF THE EMBODIMENTS

In the following, embodiments for embodying the present invention are explained by using the drawings. Configurations shown in the following embodiments are merely exemplary and the present invention is not limited to the configurations shown schematically.

### First Embodiment

### <Configuration of System>

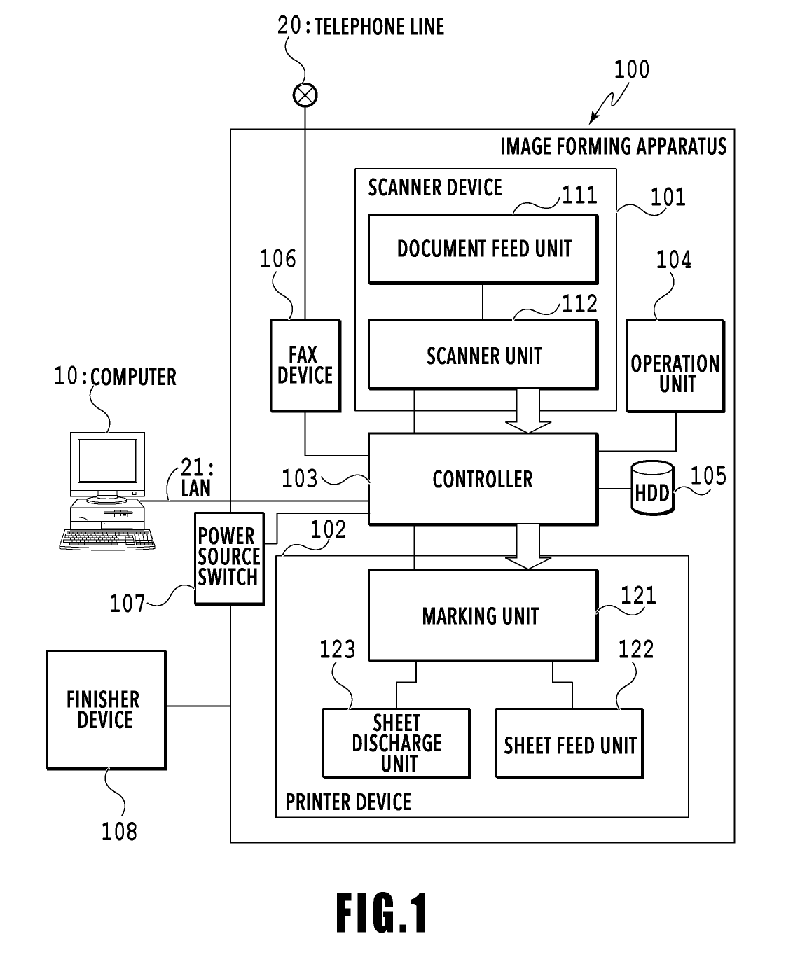

FIG. 1 is a block diagram showing a configuration of an image forming system according to a first embodiment. As shown in FIG. 1, the image forming system according to the present embodiment includes an image forming apparatus (also called information processing apparatus) 100 and a computer 10. The image forming apparatus 100 and the computer 10 are connected via a LAN 21. In FIG. 1, one computer is illustrated, but to the image forming apparatus 100, any number of computers may be connected. In the following, explanation is given by taking the case as an example where the image forming apparatus 100 is a multi function printer including a print function, a scanner function, a data communication function, and so on.

As shown in FIG. 1, the image forming apparatus 100 has a scanner device 101, a printer device 102, a controller 103, an operation unit 104, an HDD (Hard Disk Drive) 105, a FAX device, a power source switch 107, and a finisher device 108. Further, the image forming apparatus 100 is configured so as to be capable of receiving a job from the computer 10 via the LAN 21.

The scanner device 101 has a document feed unit 111 and a scanner unit 112. The scanner device 101 optically reads a document and converts into digital image data. Hereinafter, digital image data is represented simply as image data. The printer device 102 outputs image data onto a printing medium (in the present embodiment, sheet). The operation unit 104 includes a touch panel, a hard key, and so on and receives a setting for the image forming apparatus 100, displays a processing state, and so on. The HDD 105 stores image data, control programs, and so on. The FAX device 106 performs transmission and reception of image data via a telephone line 20 and the like.

The controller 103 is connected with the scanner device 101, the printer device 102, the operation unit 104, the HDD 105, and the FAX device 106 and performs various jobs received by the image forming apparatus 100 by giving instructions to those devices. Further, the controller 103 is connected with the power source switch 107.

It is possible for the image forming apparatus 100 to receive input/output of image data, issuance of a job, instructions to each device, and so on from the computer 10 via the LAN 21. The scanner device 101 has the document feed unit 111 capable of automatically exchanging a bundle of documents at any time and the scanner unit 112 capable of optically reading a document and converting into image data. The image data converted by the scanner unit 112 is transmitted to the controller 103.

The printer device 102 has a sheet feed unit 122 capable of sequentially feeding a sheet one by one from a bundle of sheets, a marking unit 121 configured to print image data on a fed sheet, and a sheet discharge unit 123 configured to discharge a sheet after printing. The finisher device 108 performs processing, such as sorting, stapling, punching, and cutting, for a sheet output from the sheet discharge unit 123 of the printer device 102 of the image forming apparatus 100.

The operation unit 104 includes a user interface (user I/F) for operating the image forming apparatus 100, for example, such as an LCD touch panel, a power-saving key, a copy button, a cancel button, a reset button, and a ten key.

The power source switch 107 controls supply of power to the image forming apparatus 100. For example, in the case where the power source switch 107 is on, power is supplied at least to a power source control unit 309, to be described later, the operation unit 104, and a part of a main board 300 of the controller 103. In the case where the power source switch 107 is turned off, supply of power is not stopped immediately, but supply of power to the portions other than a part of the power source control unit 309, to be described later, and the like, which are necessary for the power source switch 107 to turn on, is stopped after the termination processing of software and hardware is completed.

### <Functions of Image Forming Apparatus>

In the following, functions possessed by the image forming apparatus 100 are explained. The functions shown in the following are examples of the functions possessed by the image forming apparatus 100 and the image forming apparatus 100 may have other functions.

### [Copy Function]

The image forming apparatus 100 has a copy function to store image data acquired by the scanner device 101 in the HDD 105 and at the same time to perform printing by using the printer device 102.

### [Image Transmission Function]

The image forming apparatus 100 has an image transmission function to transmit image data acquired by the scanner device 101 to the computer 10 via the LAN 21.

### [Image Storing Function]

The image forming apparatus 100 has an image storing function to store image data acquired by the scanner device 101 in the HDD 105 and to perform transmission of an image and printing of an image as needed.

### [Image Printing Function]

The image forming apparatus 100 has an image printing function to analyze image data described in, for example, a page description language (PDL), which is received from the computer 10, and to perform printing by the printer device 102.

### <Configuration of Printer Device 102>

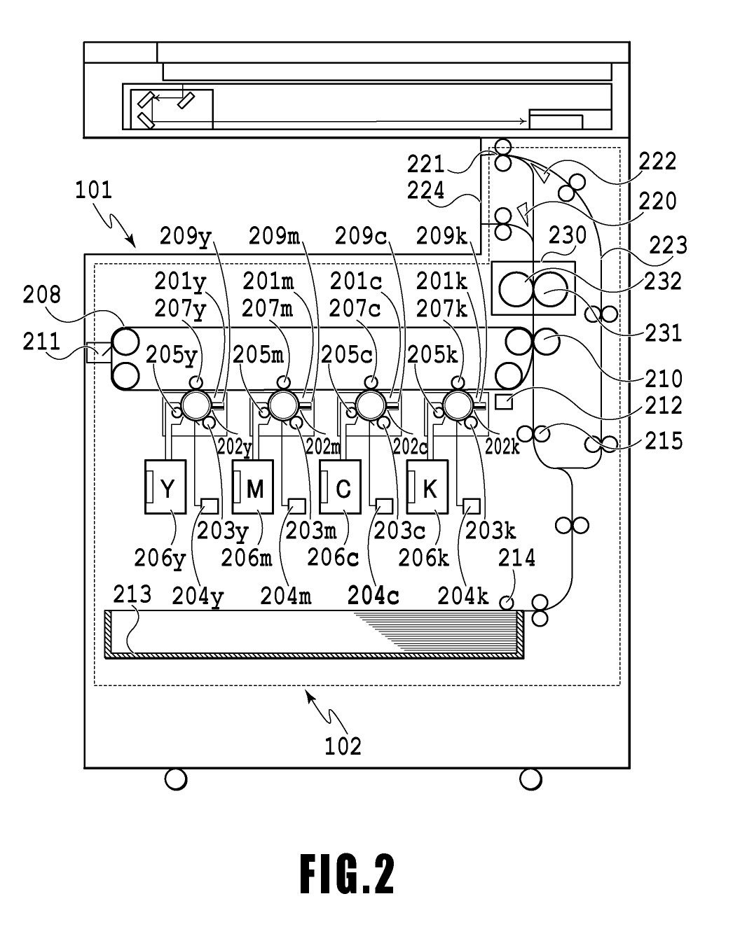

FIG. 2 is a schematic diagram of a section of the image forming apparatus 100 according to the first embodiment. In FIG. 2, a section in the case where the image forming apparatus 100 is viewed from the direction of the long side of a photoconductor drum. Further, in FIG. 2, only the internal configuration of the printer device 102 is shown. In FIG. 2, description of the components other than the scanner device 101 and the printer device 102 is omitted.

As shown in FIG. 2, the printer device 102 has a process unit 201, a laser scanner unit 204, a primary transfer roller 207, and an intermediate transfer body 208. The process unit 201 has a photoconductor drum 202, a charging roller 203, a development device 205, a toner bottle 206, and an auxiliary electrification brush 209. The process unit 201, the laser scanner unit 204, and the primary transfer roller 207 are provided for each of black (K), yellow (Y), magenta (M), and cyan (C). In the following, in the case where the process unit 201, the photoconductor drum 202, the charging roller 203, the development counter 205, the toner bottle 206, and the auxiliary electrification brush 209 are described, it is assumed that each color of K, M, Y, and C is included.

Here, the operation of the printer apparatus 102 is explained. The configuration of process units 201k, 201y, 201m, and 201c is the same, and therefore, the processing unit of black (K) (process unit 201k) is explained here. The process unit 201k has a photoconductor drum 202k, a charging roller 203k, a development counter 205k, a toner bottle 206k, and an auxiliary electrification brush 209k. The photoconductor drum 202k is accommodated at the center portion of the process unit 201k and rotationally driven by a drum motor, not shown schematically. The charging roller 203k electrifies the surface of the photoconductor drum 202k uniformly by applying a high voltage. A laser scanner unit 204k performs laser exposure on the photoconductor drum 202k electrified uniformly in accordance with input image information and forms an electrostatic latent image. At this time, the laser scanner unit 204k performs laser exposure by scanning the laser modulated and output from a laser diode in the longitudinal direction by using a polygon mirror rotation body. The development counter 205k forms a visible toner image in accordance with the electrostatic latent image on the photoconductor drum 202k by a two-component developer including toner and a carrier. The toner bottle 206k is filled with toner and from the toner bottle 206k, toner is supplied to the corresponding development counter 205k. A primary transfer roller 207k transfers (primary transfer) a visible toner image formed on the photoconductor drum 202k to an intermediate transfer body 208, which is an endless belt-shaped member, in order to sequentially overlap each color of Y, M, C, and K. The auxiliary electrification brush 209k performs electrification so that the toner remaining after transfer, which is not transferred by the primary transfer roller 207k, has uniform charge.

The printer device 102 further has a secondary transfer roller 210, an intermediate transfer body cleaner 211, a pattern density detection sensor 212, a sheet cassette 213, a sheet feed roller 214, and a registration roller 215.

The secondary transfer roller 210 secondarily transfers the toner image primarily transferred to the intermediate transfer body 208 onto a sheet. The intermediate transfer body cleaner 211 cleans remaining toner that is not transferred by the secondary transfer roller 210 and a toner image for image quality adjustment, which is not intended to be transferred onto a sheet. The pattern density detection sensor 212 detects a change in density of a pattern formed on the intermediate transfer body 208. By feeding back the detection results of the pattern density detection sensor 212 to the development counter 205 and the laser scanner unit 204, image quality adjustment is performed. The sheet cassette 213 stores sheets. The sheet feed unit 214 feeds a sheet from the sheet cassette 213 at timing at which the toner image and the front end of the sheet coincide with each other at the time of the printer device 102 transferring the toner image onto the sheet. After this, the sheet fed from the sheet cassette 213 is sent to the secondary transfer roller 210 after skew is corrected by the registration roller 215.

The printer apparatus 102 further has a both-side reverse path 220, a reverse roller 221, a reverse flapper 222, a both-side conveyance path 223, a sheet discharge unit 224, a sheet discharge flapper 225, a fixing device 230, a pressure roller 231, and a fixing film unit 232. The fixing device 230 has the fixing film unit 232 and the pressure roller 231.

The fixing device 230 thermally fixes the toner image transferred onto a sheet by the secondary transfer roller 210 onto the sheet. After this, the conveyance direction of the sheet onto which the toner image is thermally fixed is switched by the sheet discharge flapper 225 and the sheet is conveyed to the sheet discharge unit 224 or the both-side reverse path 220. Specifically, in the case where image formation on one side of a sheet is set, the sheet is conveyed to the sheet discharge unit 224 and in the case where image formation on both sides of a sheet is set, the sheet is conveyed to the both-side reverse path 220. The sheet conveyed to the both-side reverse path 220 is conveyed to the registration roller 215 via the both-side conveyance path 223 by the reverse roller 221 and the reverse flapper 222 and after an image is formed on the backside of the sheet, the sheet is conveyed to the sheet discharge unit 224.

### <Configuration of Controller>

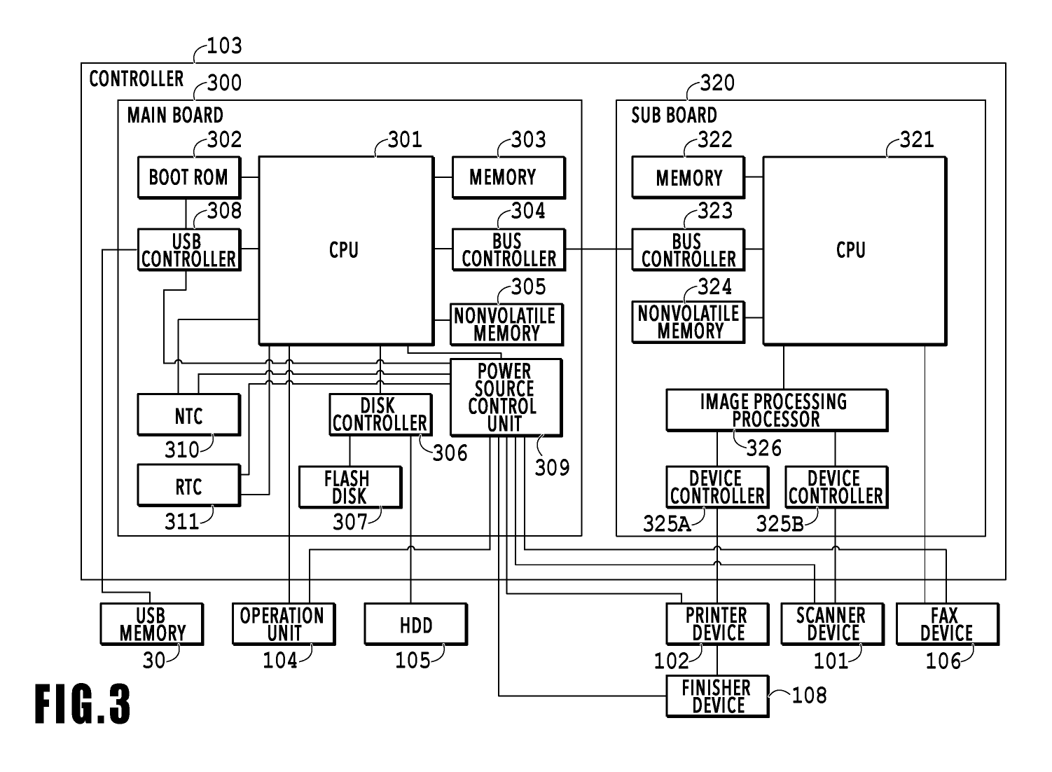

Next, by using FIG. 3, the internal configuration of the controller 103 is explained. As shown in FIG. 3, the controller 103 has the main board 300 and a sub board 320. The main board 300 is a so-called general-purpose CPU system. The main board 300 has a CPU 301 that controls the entire board, a boot ROM 302 in which a boot program is included, and a memory 303 that the CPU 301 uses as a work memory. Further, the main board 300 has a bus controller 304 having a bridge function with an external bus and a nonvolatile memory 305 that holds stored data even in the case where the power source is turned off. Further, the main board 300 has a disk controller 306 that controls a storage device (here, HDD 105) and a flash disk 307, such as an SSD, which is a comparatively small-capacity storage device made up of a semiconductor device. Further, the main board 300 has a USB controller 308 that controls USB communication with a USB device (here, USB memory 30), a network controller (NTC) 310, and a real time clock (RTC) 311. Furthermore, the main board 300 has the power source control unit 309.

The CPU 301 is connected with the operation unit 104, the NTC 310, the RTC 311, the USB controller 308, and so on. Further, the CPU 301 is connected with the operation unit 104, the scanner device 101, the printer device 102, the FAX device 106, the finisher device 108, and so on outside the controller 103 via the power source control unit 309. The power source control unit 309 controls an interrupt from each device and supply of power to each device. The power source control unit 309 in the present embodiment is implemented by a CPLD (Complex Programmable Logic Device: combined programmable logic circuit) programmed so as to perform a desired operation.

The sub board 320 has a comparatively small general-purpose CPU system and image processing hardware. More specifically, the sub board 320 has a CPU 321 that controls the entire board and a memory 322 that the CPU 321 uses as a work memory. Further, the sub board 320 has a bus controller 323 having a bridge function with an external bus and a nonvolatile memory 324 that holds stored data even in the case where the power source is turned off. Furthermore, the sub board 320 has an image processing processor 326 that performs real-time digital image processing and device controllers 325A and 325B. The scanner device 101 and the printer device 102 arranged outside the controller 103 perform transmission and reception of image data via the device controllers 325A and 325B and the image processing processor 326. The FAX device 106 is controlled directly by the CPU 321.

In FIG. 3, for simplification of explanation, description is given by omitting part of the components. For example, in the CPU 301, the CPU 321, and so on, a large number of pieces of CPU peripheral hardware, such as a chipset, a bus bridge, and a clock generator, are included, but in FIG. 3 those are omitted. That is, the configuration of the controller 103 is not limited to the block configuration shown in FIG. 3.

### <Operation of Controller>

The operation of the controller 103 is explained by taking the operation at the time of performing the copy function as an example. In the case where a user presses down a copy button of the operation unit 104, the CPU 301 sends an image read command to the scanner device 101 via the CPU 321. The scanner device 101 optically scans a document and converts into image data and inputs the image data to the image processing processor 326 via the device controller 325B. The image data input to the image processing processor 326 is transferred to the memory 322 by DMA transfer and saved temporarily.

In the case where it is possible for the CPU 301 to check that a predetermined amount or all of the image data received from the scanner device 101 is saved in the memory 322, the CPU 301 gives image output instructions to the printer device 102 via the CPU 321. The CPU 321 notifies the image processing processor 326 of the address of the image data on the memory 322. The image data on the memory 322 is transmitted to the printer device 102 via the image processing processor 326 and the device controller 325A in accordance with a synchronization signal from the printer device 102. The printer device 102 prints the image data on a sheet. In the case where instructions to print a plurality of copies are given by a user, the CPU 301 transfers the image data on the memory 322 to the HDD 105 and the like and saves the image data. Due to this, it is made possible to perform printing of the second and subsequent copies by sending the image data saved in the HDD 105 and the like to the printer device 102 without the need to receive the image data from the scanner device 101.

### <Power Source Configuration>

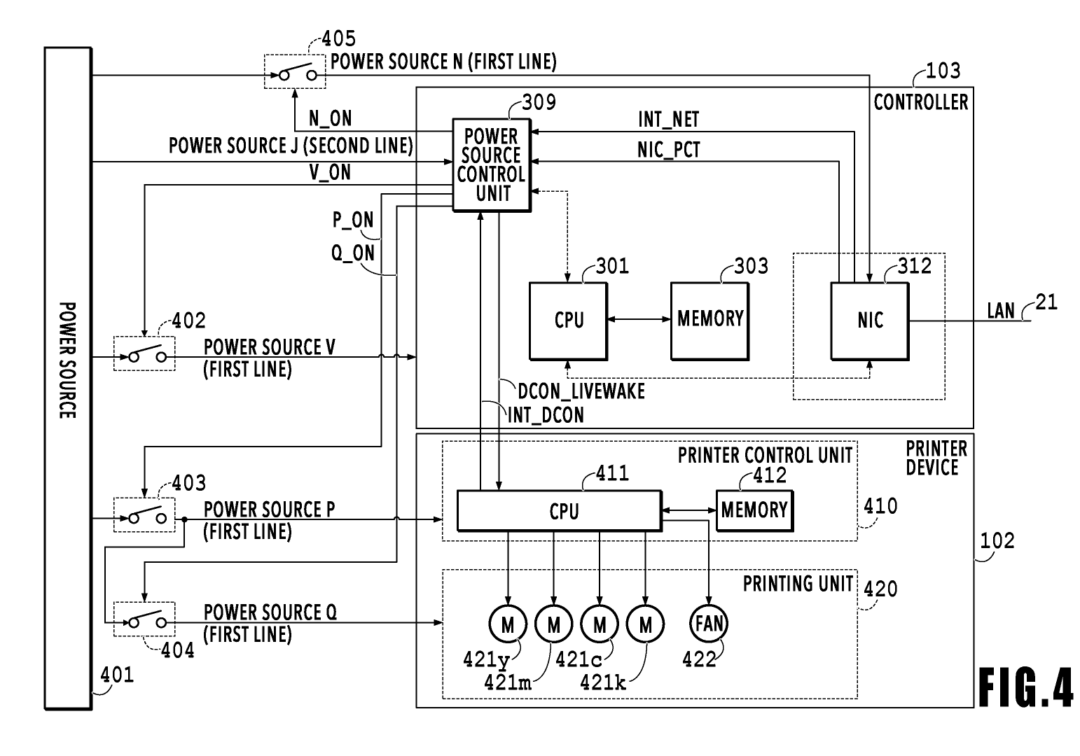

FIG. 4 is a block diagram showing a power source configuration of the image forming apparatus 100 according to the first embodiment. FIG. 4 shows the way power is supplied from a power source 401 included in the image forming apparatus 100 to the controller 103 and the printer device 102. A broken line bidirectional arrow shown in FIG. 4 indicates the way communication is performed between devices at both ends of the arrow.

In FIG. 4, to the power source control unit 309 of the controller 103, power is supplied at all times via a power source line J, which is a first power source line. In the following, there is a case where a power source line X is represented simply as a power source X. The power consumption by the power source control unit 309 is very small, and therefore, power is supplied to the power source control unit 309 also in the case where the power source is off and power control is performed.

As described above, the power source control unit 309 is programmed in advance so as to perform a desired operation. Here, the operation performed by the power source control unit 309 in the present embodiment is explained. In the present embodiment, the power source control unit 309 switches a relay switch 402 by an IO signal V_ON, which is a first power source control signal. As a result of this, the power supplied to the controller 103 from the power source 401 via a power source line V, which is a second power source line, is controlled. In the power source control unit 309, a plurality of timer values is set by communication from the CPU 301 and the power source control unit 309 performs the operation set by the CPU 301 at the time of activation of the timer. Hereinafter, a power source line that passes the relay switch and through which power is supplied in the case where the relay switch is in the on-state is called a first line. Further, a power source line that does not pass the relay switch is called a second line.

Furthermore, the power source control unit 309 switches a relay switch 403 by an IO signal P_ON, which is a second power source control signal. As a result of this, the power supplied to a printer control unit 410 of the printer device 102 from the power source 401 via a power source line P, which is a third power source line, is controlled. The printer control unit 410 is a logic-based circuit and has a CPU 411 and a memory 412 as shown in FIG. 4. Further, the power source control unit 309 switches a relay switch 404 by an IO signal Q_ON, which is a sub signal of the second power source control signal. As a result of this, the power supplied to a printing unit 420 of the printer device 102 from the power source 401 via a power source line Q, which is a sub line of the third power source line, is controlled. The marking unit 121 of the printing unit 420 has a motor 421 (421c, 421m, 421y, 421k), which is a high-load system, and a fan 422. The motor 421 is provided for each color and drives the photoconductor drum 202 in the corresponding color. The fan 422 is a discharge fan for discharging air within the printer device 102 (gas within the image forming apparatus 100) to the outside. For simplification of explanation, in FIG. 4, as the components of the printer device 102, only the above-described components are described. Further, the power source line Q does not need to be the sub line of the power source line P and it is also possible to route the power source line Q from the power source 401. Further, it is also possible to control the relay switch 404 by the CPU 411 and the like in place of the power source control unit 309. Further, the power source control unit 309 causes the predetermined IO signal to operate in accordance with instructions of the CPU 301. One of the IO signals caused to operate by the power source control unit 309 is a DCON_LIVEWAKE signal connected to the CPU 411 of the printer control unit 410 of the printer device 102. In the case where the power source of the printer device 102 is turned on in the state where the DCON_LIVEWAKE signal is asserted, the printer device 102 returns without performing a specific operation, such as controlling a movable unit and using power. Then, the printer device 102 notifies the power source control unit 309 of the return by outputting an INT_DCON signal. The specific operation referred to here includes control, for example, such as the rotation operation of a roller, a polygon, and so on, temperature adjustment of the motors 421c, 421m, 421y, and 42k, and heat discharge processing by the fan 422. Here, the operation to control supply of power to the printer device 102 is explained, but supply of power to the scanner device 101 is also controlled similarly. For simplification of explanation, explanation of power control for the scanner device 101 is omitted.

Further, the power source control unit 309 switches a relay switch 405 by an IO signal N_ON, which is a third power source control signal. As a result of this, the power supplied to a NIC 312 of the controller 103 via a power source line N, which is a fourth power source line, is controlled. As described above, in the present embodiment, only to the NIC 312 of each block within the controller 103, power is supplied individually by the power source line N. Unlike the other first lines, the power source line N supplies power not only at the normal time but also at the time of sleep and enables a network wake-up. At the time of shutdown, unless the setting, such as Wake On LAN, is effective, the power source line N does not supply power. As described above, in the present embodiment, the relay switch connected to the controller 103 includes two systems. Then, one relay switch is connected to the block whose power source is turned off at the time of the sleep state and the other relay switch is connected to the block whose power source is left on at the time of the sleep state. Further, in the sleep state, only the one relay switch that is connected to the block whose power source is turned off is turned off and the other relay switch is left on, and in the shutdown state, both the relay switches are turned off. By the control such as this, each power state (sleep state, shutdown state, and so on described previously) in the image forming apparatus 100 (more specifically, the controller 103) is implemented.

### <Supply of Power at the Time of Activation>

Following the above, activation processing of the image forming apparatus 100 is explained. In the case where a user uses the image forming apparatus 100, the power source switch 107 is turned on Then, the power source control unit 309 detects that the power source is turned on from the power source line J and turns on the relay switches 402 and 403 respectively by the power source control signals V_ON and P_ON. Due to this, power is supplied to the entire apparatus from the power source 401. At this time, the power source control unit 309 performs supply of power in accordance with the time at which the power source is on for the entire apparatus. Specifically, the power source control unit 309 performs energization for the controller 103, the printer device 102, and the scanner device 101 via the DC power source supply path corresponding to each. In the case where the energization is performed, the CPU of each of the printer device 102 and the scanner apparatus 101 starts the initialization operation accompanying the turning on of the power source. The CPU 301 of the controller 103 performs hardware initialization and then performs software initialization. The hardware initialization includes register initialization, interrupt initialization, registration of a device driver at the time of activation of a kernel, initialization of the operation unit 104, and so on. The software initialization includes a call of an initialization routine of each library, activation of process and thread, activation of software service that performs communication with the printer device 102 and the scanner device 101, drawing for the screen of the operation unit 104, and so on. Then, the power source control unit 309 makes transition into the standby state.

### <Supply of Power in Normal State>

Following the above, supply of power of the image forming apparatus 100 in the normal state where a user is not using the printer device 102 or the scanner device 101 is explained. The normal state also includes a state where power is not supplied to the printer device 102 in the case where the printer device 102 is not performing printing, not only the state where power is supplied to all the units. Further, a state where power is not supplied to the scanner device 101 in the case where it is known that the operation unit 104 is not lit and no user exists in front of the image forming apparatus 100, or the like is also included.

Further, in the normal state, an operation-waiting state is also included. The operation-waiting state is a state where a predetermined module or function is caused not to operate while supplying power to both the printer device 102 and the scanner device 101 in order to complete printing of the printer device 102 and reading of the scanner device 101 earlier. In the operation-waiting state, for example, the motor or the polygon for printing is caused not to operate, temperature adjustment of the transfer unit for printing is caused not to be performed, home position detection for reading is caused not to be performed, and so on.

### <Supply of Power at the Time of PDL Printing>

Following the above, supply of power in the case where the image forming apparatus 100 is in a PDL printing state is explained. Here, turning on of the power source and turning off of the power source of the printer device 102 in the case where the printer device 102 is in use, that is, in the case where the image printing function is being made use of are explained.

The CPU 301 of the controller 103 receives data from the computer 10 via the LAN 21 and saves the data in the memory 303. The CPU 301 analyzes the received data and generates a print job in the case of performing the image printing function. The CPU 301 gives a notification to the power source control unit 309, switches the relay switch 403 by the power source control signal P_ON, and supplies power to the printer device 102 from the power source 401 via the power source line P. The CPU 301 performs the print job in the case where the printer device 102 enters the usable state. The CPU 301 transmits the data saved in the memory 303 to the CPU 321 of the sub board via the bus controller 304 and the bus controller 323 of the sub board. The CPU 321 of the sub board transmits the received data to the printer device 102 via the image processing processor 326 and the device controller 325A. The printer device 102 prints the received data and notifies the CPU 301 of the printing execution results upon completion of printing. Upon receipt of the printing execution results, the CPU 301 turns off the relay switch 403 by the power source control signal P_ON via the power source control unit 309 and turns off the power source of the printer device 102.

<Supply of Power at the Time of Transition into Sleep>

Following the above, supply of power at the time of the image forming apparatus 100 making transition into the sleep state is explained. In the case where a state where a user does not perform any operation in the standby state continues for a predetermined time, the CPU 301 makes transition into the sleep state where power consumption is smaller than that in the standby state. Further, the CPU 301 makes transition into the sleep state also in the case where the power-saving key on the operation unit 104 is pressed down, in the case where a time set in advance is reached, and so on. The CPU 301 notifies the power source control unit 309 of the transition into the sleep state and changes the supply of power to the controller 103. At this time, as described previously, only the relay switch connected to the block of the blocks within the controller 103, whose power source is turned off at the time of the sleep state, is turned off. Further, the relay switch connected to the block of the blocks within the controller 103, whose power source is left on at the time of the sleep state, is left on. In the following, there is a case where a state (operation-waiting state or standby state described above) where power is supplied to a target device of device adjustment processing, to be described later, is called a first power state and a state (sleep state and the like) where supply of power to the device is stopped is called a second power state.

### <Supply of Power at the Time of Sleep>

Following the above, supply of power in the case where the image forming apparatus 100 is in the sleep state is explained. At the time of the sleep state, power is supplied to the memory 303, the NTC 310, the RTC 311, the USB controller 308, an interrupt controller (not shown schematically), and so on within the controller 103. Further, power is also supplied to the power-saving key of the operation unit 104, a part of the FAX device 106, various sensors, and so on. However, the sleep return factor (factor to return from the sleep state) is different depending on the system, and therefore, the supply of power in the sleep state is not limited to the above-described aspect.

<Supply of Power at the Time of Return from Sleep>

Following the above, supply of power at the time of the image forming apparatus 100 returning from the sleep state is explained. The power source control unit 309 receives an interrupt from the NTC 310 that detects network communication, the RTC 311 that detects a timer and alarm, and the USB controller 308 that detects insertion and extraction of a USB device and communication with a USB device. Further, the power source control unit 309 receives an interrupt from the FAX device 106 that detects an incoming call and off-hook, a software switch, and various sensors. In the case of receiving an interrupt during sleep, the power source control unit 309 starts supply of power. Then, the power source control unit 309 notifies the CPU 301 of the interrupt factor. Then, upon receipt of the notification, the CPU 301 performs processing to return the supply of power and the state of the software to the normal state (specifically, the normal state where power is supplied to the printer device 102 and the scanner device 101), that is, sleep return processing. Here, the sleep return processing is explained.

First, the sleep return processing in the case where an event of pressing down of the power-saving key, which is the sleep return factor, occurs during sleep is explained. In the case where the power source control unit 309 receives an interrupt corresponding to the sleep return factor, the CPU 301 returns from the sleep state. After returning from the sleep state, the CPU 301 notifies the power source control unit 309 of the return from sleep. After this, the power source control unit 309 turns on the relay switches 402 and 403 by the power source control signals V_ON and P_ON. As a result of this, supply of power to the controller 103, the printer device 102, and the scanner device 101 is started. The power source control signal for the scanner device 101 is not shown in FIG. 4, but it may also be possible to share the power source control signal of the printer device 102, or to separately prepare a power source control signal for the scanner device 101.

In the case where the print job is completed, the CPU 301 makes transition into the sleep mode again. The CPU 301 notifies the power source control unit 309 of the transition into sleep and the power source control unit 309 turns off the relay switch 403 by the power source control signal P_ON and stops supply of power except for that to the controller 103.

Next, the sleep return processing in the case where a network reception event, which is the sleep return factor, occurs is explained. The power source control unit 309 receives an interrupt corresponding to the sleep return factor and turns on the relay switch 402 by the power source control signal V_ON and starts supply of power to the controller 103. Due to this, the CPU 301 returns from the sleep state. In the case where a job is not generated at the time of return from sleep, such as a case where return from sleep takes place by receiving a PING command, it may also be possible not to supply power to the printer device 102 and the scanner device 101. Further, in the case where it is not necessary to acquire device information (sheet size setting and the like) from the printer device 102 and the scanner device 101 at the time of return from sleep, it may also be possible not to supply power to the printer device 102 and the scanner device 101.

### <Operation of First Embodiment of Controller 103>

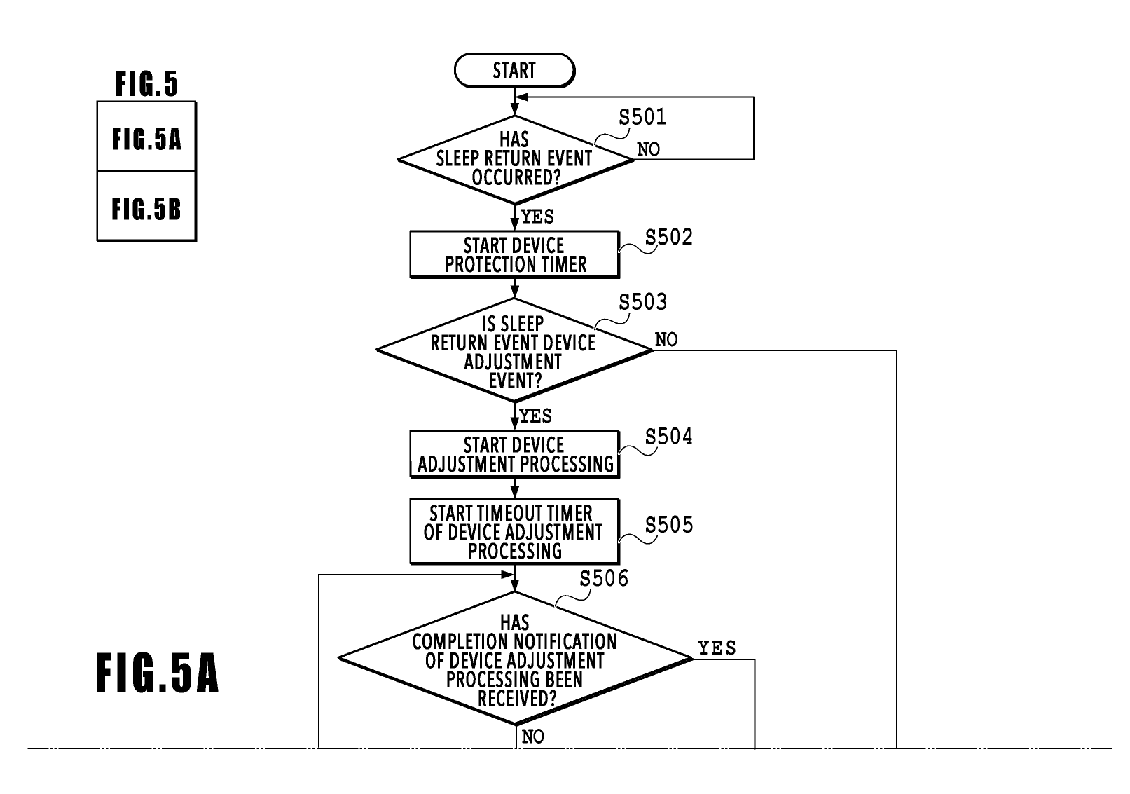

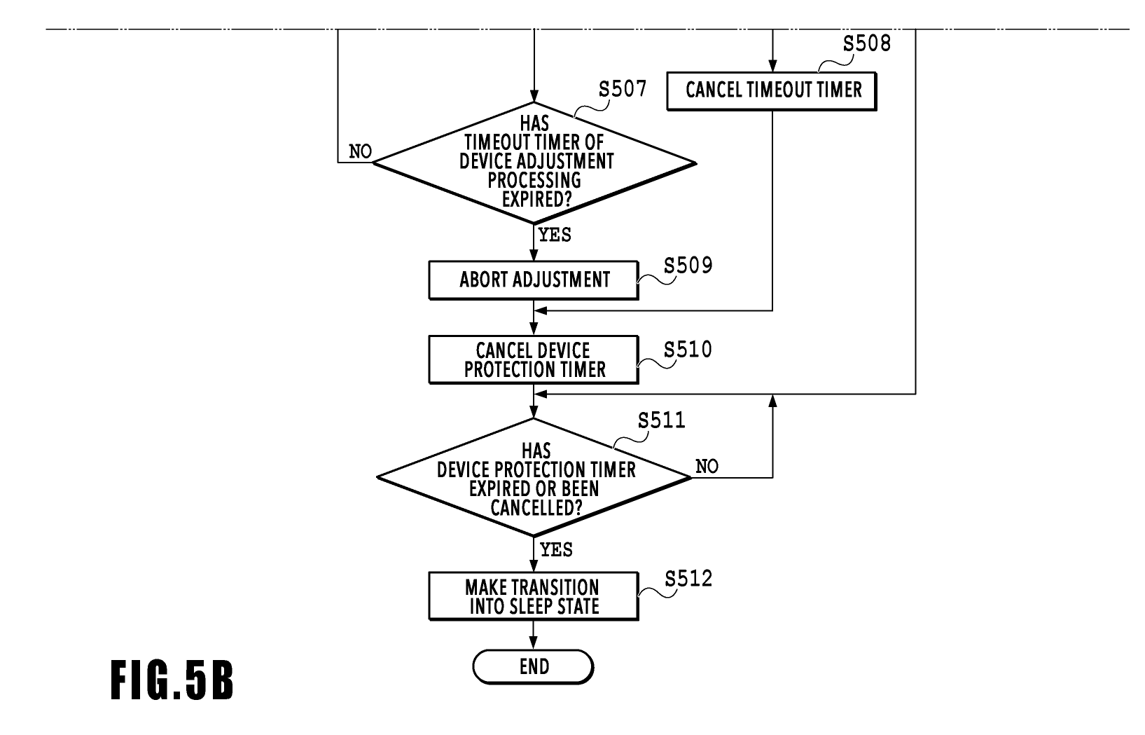

FIG. 5A and FIG. 5B are flowcharts showing the operation of the first embodiment of the controller 103. As explained in the following, the controller 103 in the present embodiment immediately makes transition into the sleep state in the case where the slight rotation or the automatic gradation correction described previously is completed, which is performed at predetermined time intervals during sleep by the controller 103 returning from sleep.

The CPU 301 monitors whether an event, which is the sleep return factor, (hereinafter, called a sleep return event) has occurred at the time of the sleep state or at the time of the standby state (step S501). Upon receipt of an RTC interrupt or an interrupt by network reception, the CPU 301 determines that a sleep return event has occurred (YES at step S501) and starts a timer (called a device protection timer) for protecting a device (step S502). The device protection timer is a timer for preventing the relay switch and the like from being turned on and off frequently by preventing the device from returning to sleep before a predetermined time (for example, 10 min.) elapses after returning from sleep. It is desirable for the time of the device protection timer to be set in a range that does not increase the energization time of a device more than necessary. Next, the CPU 301 checks whether the sleep return event is a device adjustment event (step S503). Whether the sleep return event is a device adjustment event is determined by, for example, determining whether instructions to start device adjustment processing have been registered in association with the specified time of an RTC alarm in the case where return from sleep takes place by an RTC interrupt. The device adjustment processing is, as described previously, the slight rotation to shift the crimped surface by rotating the fixing film unit 232 of the fixing device 230 and the pressure roller 231 by a small angle, or the automatic gradation correction. Further, for example, in the case of the return by an interrupt by network reception, the determination is performed by determining whether the command received via a network is a command including instructions to start device adjustment processing. The example of the device adjustment event is not limited to those. Further, the device adjustment processing may include processing to rotate the photoconductor drum 202 by a small angle, processing to rotate the fan 422 for a predetermined time, and so on.

In the case where the sleep return event is not a device adjustment event (NO at step S503), the CPU 301 advances to the processing at step S511 without performing the device adjustment processing. In the case where the sleep return event is a device adjustment event (YES at step S503), the CPU 301 starts a timeout timer of the device adjustment processing as well as making a request to start the device adjustment processing (steps S504, S505). At this time, the CPU 301 makes a request to start the device adjustment processing to the CPU 321 of the sub board 320 via the bus controllers 304 and 323. Then, the CPU 321 of the sub board 320 makes a request to start the device adjustment processing to the CPU 411 of the printer device 102 via the image processing processor 326 and the device controller 325A. The CPU 411 of the printer device 102 having received the request performs the device adjustment processing. The timeout timer of the device adjustment processing is a timer that times the time set in advance by taking into consideration the case where it is not possible to complete the device adjustment processing for some reason.

Next, the CPU 301 checks whether a completion notification of the device adjustment processing has been received (S506). The completion notification of the device adjustment processing is performed by the process opposite to that of the start notification. That is, the CPU 411 of the printer device 102 notifies the CPU 321 of the sub board 320 of the controller 103 of the completion of the device adjustment processing via the device controller 325A and the image processing processor 326. The CPU 321 of the sub board 320 notifies the CPU 301 of the completion of the device adjustment processing via the bus controllers 323 and 304.

In the case where the completion notification of the device adjustment processing has not been received (NO at step S506), the CPU 301 checks whether the timeout timer of the device adjustment processing has expired, that is, the time set in advance to the timeout timer has been timed (step S507). In the case where the timeout timer has not expired (NO at step S507), the processing returns to step S506. In the case where the completion notification of the device adjustment processing has not been able to be received due to the expiration of the timeout timer (YES at step S507), the CPU 301 aborts the device adjustment processing (step S509). In the present embodiment, the CPU 301 performs cancel notification of the device adjustment processing for the CPU 411 of the printer device 102. The cancel notification of the device adjustment processing is performed by the process opposite to that of the start notification. At this time, there is a possibility that the cancel notification does not reach the printer device 102 in a certain state where it is not possible to complete the device adjustment processing. Consequently, it may also be possible for the CPU 301 to advance to the processing at step S510 without performing the cancel notification. It may also be possible to implement the cancel notification of the device adjustment processing performed between the CPU 301 and the CPU 411 of the printer device 102 by notification by a port, such as the DCON_LIVEWAKE signal and the INT_DCON signal shown in FIG. 4.

In the case where the completion notification of the device adjustment processing has been received (YES at step S506), the CPU 301 cancels the timeout timer of the device adjustment processing (step S508) and advances to the processing at step S510.

At step S510, the CPU 310 cancels the device protection timer. Then, at step S511, the CPU 301 checks whether the device protection timer has expired or has been cancelled. In the case where the device protection timer has not expired and has not been cancelled (NO at step S511), the CPU 301 repeats the processing at step S511. In the case where the device protection timer has expired or has been cancelled (YES at step S511), the CPU 301 causes the image forming apparatus 100 (controller 103) to make transition into the sleep state (step S512).

As above, in the present embodiment, in the case where the device adjustment processing is completed or aborted, the device protection timer that is started at the time of return from sleep is cancelled. Due to this, it is possible for the image forming apparatus 100 to make transition into the sleep state immediately after completion of the device adjustment processing. That is, according to the present embodiment, it is possible to suppress power consumption at the time of returning from sleep by a device adjustment event. Due to this, it is possible to reduce the power consumption of the entire image forming apparatus.

In the present embodiment, the operation is explained in which the CPU 301 cancels the device protection timer in the case where the device adjustment processing is completed or aborted. However, in the case where the use frequency of the image forming apparatus 100 is high, that is, the job frequency is high or the job interval is short, the possibility that a job is performed before the device protection timer expires is strong. Consequently, by taking into consideration the convenience of a user, it may also be possible to design the image forming apparatus 100 so as to wait for the device protection timer to expire in place of making transition into the sleep state immediately after completion of the device adjustment processing. Further, it may also be possible to design the image forming apparatus 100 so as not to make transition into the sleep state in the case where the number of times the power source is turned on within a predetermined period of time exceeds a predetermined number of times from the viewpoint of device protection.

### Second Embodiment

In the first embodiment, the image forming apparatus is taken as an example, which makes transition into the sleep state immediately after completion of device adjustment processing by cancelling the device protection timer in the case of receiving the completion notification of the device adjustment processing. In a second embodiment, an image forming apparatus is taken as an example, which makes transition into the sleep state immediately after completion of device adjustment processing by not starting the device protection timer in the case where the sleep return event is a device adjustment event.

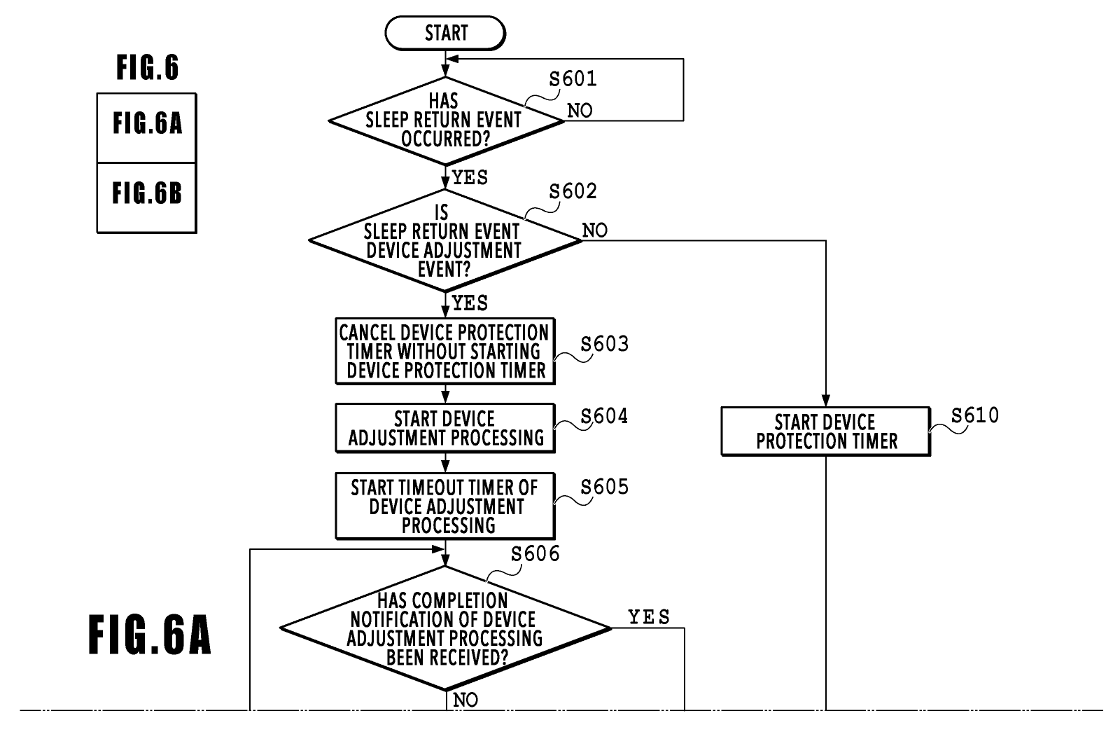

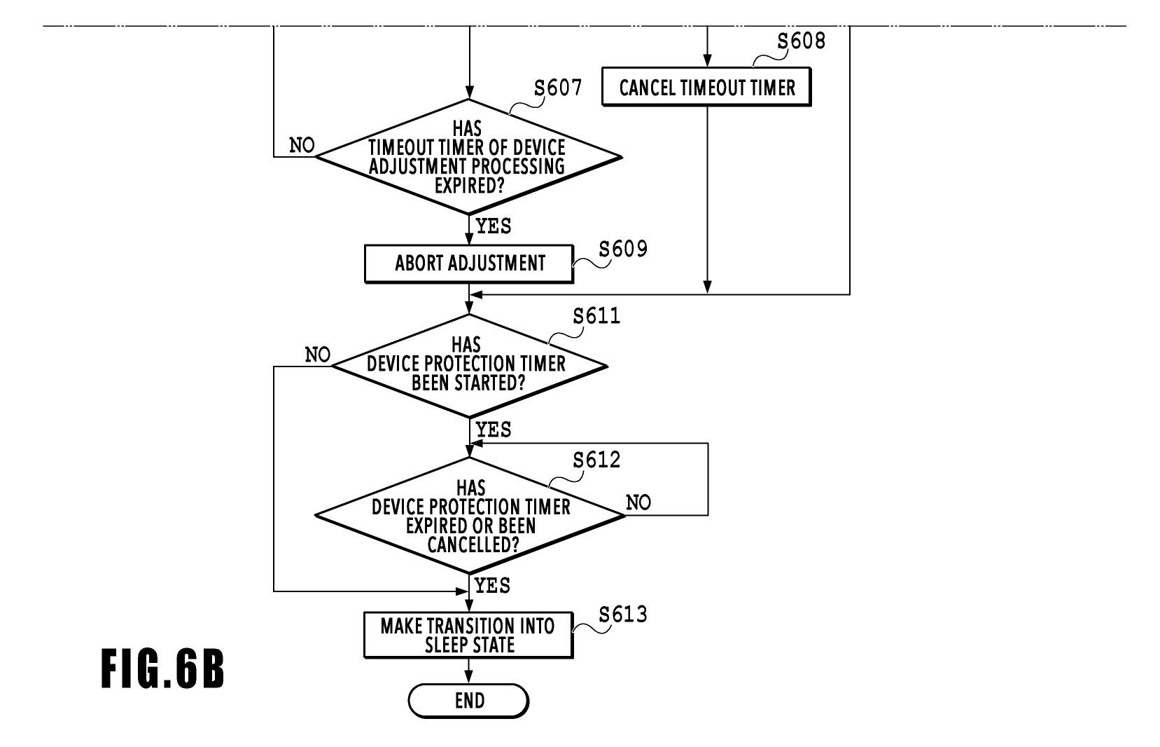

The configuration of the image forming apparatus 100 in the second embodiment is the same as that of the image forming apparatus 100 in the first embodiment, and therefore, explanation is omitted. In the following, the operation of the image forming apparatus 100 in the second embodiment is explained. FIG. 6A and FIG. 6B are flowcharts showing the operation of the second embodiment of the controller 103.

The CPU 301 monitors where a sleep return event has occurred at the time of the sleep state or the standby state (step S601). The processing at step S601 is the same as the processing at step S501. In the case of determining that a sleep return event has occurred (YES at step S601), the CPU 301 checks whether the sleep return event is a device adjustment event (step S602). The processing at step S602 is the same as the processing at step S503.

In the case where the sleep return event is not a device adjustment event (NO at step S602), the CPU 301 starts the device protection timer (step S610). Then, the CPU 301 advances to the processing at step S611 without performing the device adjustment processing.

In the case where the sleep return event is a device adjustment event (YES at step S602), the CPU 301 makes a request to start the device adjustment processing without starting the device protection timer (steps S603, S604). Then, the CPU 301 starts the timeout timer of the device adjustment processing (step S605). There is a case where the device protection timer has already been started at the time of execution of step S603. For example, there is a case where the CPU 301 has received an interrupt by the sleep return event other than the device adjustment event in advance. In such a case, at step S603, the CPU 301 cancels the device protection timer having already been started.

The processing at steps S606 to S609 is the same as the processing at steps S506 to S509. In the present embodiment, different from the first embodiment, the device protection timer is not cancelled after the device adjustment processing is completed or aborted. The reason is that the device protection timer is prevented from being started before the execution of the device adjustment processing is started. Further, the reason is that the device protection timer having already been started is cancelled before the device adjustment processing is performed.

At step S611, the CPU 301 checks whether the device protection timer has been started. In the case where the device protection timer has been started (YES at step S611), the processing advances to step S612. In the case where the device protection timer has not been started (NO at step S611), the processing advances to step S613. The processing at steps S612 and S613 is the same as the processing at steps S511 and S512.

It may also be possible to provide a sleep prohibit flag and to set the sleep prohibit flag effective at the time of performing device adjustment processing. Then, it may also be possible to perform control so that transition into sleep is not made in the case where the sleep prohibit flag is effective during execution of the device adjustment processing. According to the aspect such as this, it is possible to prevent the state from making transition into the sleep state before the device adjustment processing is completed in a system capable of receiving the device adjustment event and another sleep return event at the same time.

As above, according to the present embodiment, as in the first embodiment, it is possible for the image forming apparatus 100 to make transition into the sleep state immediately after completion of device adjustment processing. Consequently, it is possible to obtain the same effect as that of the first embodiment.

In the above-described embodiments, as the device adjustment processing, the adjustment processing (slight rotation or automatic gradation correction) performed for the printer device 102 is taken as an example. However, it may also be possible to include an event that causes the printer device 102 and the scanner device 101 to perform adjustment processing and an event that causes only the scanner device 101 to perform adjustment processing in the device adjustment event. In the case where such a device adjustment event has occurred, it is sufficient to cause the scanner device 101 to perform the processing shown in FIG. 5A, FIG. 5B, FIG. 6A and FIG. 6B as in the case with the printer device 102.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, it is possible to reduce power consumption accompanying adjustment processing performed during sleep in an information processing apparatus, such as an image forming apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-167498, filed Aug. 31, 2017, which is hereby incorporated by reference wherein in its entirety.

What is claimed is:

1. An information processing apparatus comprising a device and a controller that controls the device, wherein
the controller has:
a power control unit capable of controlling a power state of the information processing apparatus between a first power state where at least supply of power to the device is performed and a second power state where power consumption is smaller than that of the first power state and supply of power to the device is stopped; and
a monitoring unit configured to monitor an occurrence of an event that causes the power state to return to the first power state from the second power state, and
the power control unit:
causes the power state to return to the first power state in a case where an occurrence of an event is detected by the monitoring unit; and
further returns the power state to the second power state in a case where the event that has occurred is an adjustment event for causing the device to perform adjustment processing on a condition that the adjustment processing performed in accordance with the adjustment event is completed.

2. The information processing apparatus according to claim 1, wherein
the power control unit returns the power state to the second power state in a case where the event that has occurred is an event other than the adjustment event on a condition that a predetermined time elapses after causing the power state to return to the first power state.

3. The information processing apparatus according to claim 2, comprising:
a timer for timing the predetermined time, wherein
the power control unit:
starts the timer in a case where an occurrence of an event is detected by the monitoring unit;
cancels the timer and returns the power state to the second power state in a case where the event that has occurred is the adjustment event on a condition that the adjustment processing performed in accordance with the adjustment event is completed; and
starts the timer in a case where the event that has occurred is an event other than the adjustment event and returns the power state to the second power state on a condition that the timer times the predetermined time.

4. The information processing apparatus according to claim 2, comprising:
a timer for timing the predetermined time, wherein
the power control unit, in a case where an occurrence of an event is detected by the monitoring unit:
does not start the timer in a case where the event that has occurred is the adjustment event and returns the power state to the second power state on a condition that the adjustment processing performed in accordance with the adjustment event is completed; and
starts the timer in a case where the event that has occurred is an event other than the adjustment event and returns the power state to the second power state on a condition that the timer times the predetermined time.

5. The information processing apparatus according to claim 1, wherein
the controller further comprises a request unit configured to make a request to start the adjustment processing to the device in a case where the event that has occurred is the adjustment event, and
the power control unit determines that the adjustment event is completed in a case of receiving a completion notification of the adjustment processing performed in accordance with the request of the request unit from the device.

6. The information processing apparatus according to claim 1, wherein
the second power state is a sleep state.

7. The information processing apparatus according to claim 1, wherein
the device is a printer device, and
the adjustment processing at least includes processing to rotate a pressure roller possessed by the printer device by a small angle.

8. A power control method by a controller in an information processing apparatus comprising a device and the controller that controls the device, the method comprising the steps of:
monitoring an occurrence of an event that causes a power state of the information processing apparatus to return to a first power state where at least supply of power to the device is performed from a second power state where power consumption is smaller than that of the first state and supply of power to the device is stopped;
causing the power state to return to the first power state in a case where an occurrence of an event is detected by the monitoring; and
further returning the power state to the second power state in a case where the event that has occurred is an adjustment event for causing the device to perform adjustment processing on a condition that the adjustment processing performed in accordance with the adjustment event is completed.

9. A non-transitory computer readable storage medium storing a program for causing a computer to perform a power control method by a controller in an information processing apparatus comprising a device and the controller that controls the device, the method comprising the steps of:
monitoring an occurrence of an event that causes a power state of the information processing apparatus to return to a first power state where at least supply of power to the device is performed from a second power state where power consumption is smaller than that of the first state and supply of power to the device is stopped;
causing the power state to return to the first power state in a case where an occurrence of an event is detected by the monitoring; and
further returning the power state to the second power state in a case where the event that has occurred is an adjustment event for causing the device to perform adjustment processing on a condition that the adjustment processing performed in accordance with the adjustment event is completed.
